(19) United States
(12) Patent Application Publication
(10) Pub. No.: US 2021/0037718 A1
(43) Pub. Date: Feb. 11, 2021

(54) PLANTER WITH GROW SUPPORTS

(71) Applicant: Classic Home & Garden, LLC, Monroe, CT (US)

(72) Inventors: Fred Joseph Ryan, Trumbull, CT (US); Jason Anthony Yanes, Coral Gables, FL (US)

(21) Appl. No.: 16/535,739

(22) Filed: Aug. 8, 2019

(51) Int. Cl. A01G 9/12; A01G 9/02

(52) U.S. Cl. CPC A01G 9/12; A01G 9/02

(57) ABSTRACT

A planter that includes a base with mesa structures located in a central portion of the base. Each of the mesa structure having a support receiving opening to receive a grow support. The grow support can attach to the planter at the support receiving holes to collectively form a plant support for supporting a plant growing the in the planter.

### BACKGROUND

### Technical Field

The present invention relates to planters, and more particularly to planters with grow support foundations for securing a grow support.

### Description of the Related Art

Many plants grow in a manner where the weight of foliage and fruit can cause the plant to succumb to the weight and bend and grow along the ground, limiting the growth of the plant and the number of plants that can be grown in an area. The plant growing up can then bend under the added weight of the foliage and fruit to grow along the ground.

### SUMMARY

According to embodiments of the present invention, a planter is described. The planter includes a base with at least one mesa structure in a central portion of the base, each mesa structure having a support receiving opening configured to receive a grow support, and the grow support configured to attach to the planter at the support receiving holes to collectively form a plant support to support a plant growing the in the planter.

According to other embodiments, a planter is described. A planter includes a base including a plurality of openings, at least one planter sidewall formed with the base, a grow support foundation formed on the base over each of the plurality of openings and extending substantially vertically upwards from the base, and a grow support mount on the grow support foundation for attaching a grow support to the planter.

According to embodiments of the present invention, a planter is described. The planter includes a base with at least one substantially vertical planter sidewall formed with the base, a grow support foundation attached to the at least one substantially vertical planter sidewall, and a plurality of grow support mounts on the grow support foundation for attaching a grow support to the planter.

These and other features and advantages will become apparent from the following detailed description of illustrative embodiments thereof, which is to be read in connection with the accompanying drawings.

### BRIEF DESCRIPTION OF THE SEVERAL VIEWS OF THE DRAWINGS

The disclosure will provide details in the following description of preferred embodiments with reference to the following figures wherein:

FIG. 1 is a side view of a planter with a grow support in accordance with one embodiment;

FIG. 2 is a cross-sectional view of the planter of FIG. 1 showing a planter with grow support foundations and the grow support therein in accordance with one embodiment;

FIG. 3 is a cross-sectional view of the planter of FIG. 1 showing a planter with grow supports and a plant therein in accordance with one embodiment;

FIG. 4 is a side view of a planter with removable grow support foundations therein in accordance with another embodiment;

FIG. 5 is top view of the planter in FIG. 4 with a removable grow support foundation and support mounts in accordance with another embodiment;

FIG. 6 is a removable grow support foundation in accordance with another embodiment;

FIG. 7 is a cross-sectional view of a planter with a removable grow support foundation therein in accordance with another embodiment;

FIG. 8 is top view of the planter in FIG. 7 with the removable support foundation mounts in accordance with another embodiment;

FIG. 9 is a removable grow support foundation in accordance with another embodiment

FIG. 10 is a side view of a planter with grow support foundations therein in accordance with another embodiment;

FIG. 11 is top view of the planter in FIG. 10 with a grow support foundation and grow supports in accordance with another embodiment;

FIG. 12 is a side view of a planter with a removable grow support foundation therein in accordance with another embodiment;

FIG. 13 is a top view of the planter in FIG. 12 with a removable grow support foundation and grow supports in accordance with another embodiment;

FIG. 14 is a view of grow support foundations with a grow support in accordance with another embodiment;

FIG. 15 is a view of a grow support foundation with a grow support in accordance with another embodiment;

FIG. 16 is a view of a grow support foundation with a grow support in accordance with another embodiment;

FIG. 17 is a view of a grow support foundation with a grow support in accordance with another embodiment;

FIG. 18 is a view of a grow support foundation with a grow support in accordance with another embodiment; and

FIG. 19 is a view of a grow support foundation with a grow support in accordance with another embodiment.

### DETAILED DESCRIPTION

Embodiments and aspects of an inventive planter with grow support foundations are described. To ensure placement of the grow support to optimally support any plant growing in the planter, the grow support foundation centers the grow support in the planter, thus giving the plant growing in the planter proper space to effectively grow while also reducing the amount of soil needed to fill the planter. The grow support attaches to the grow support foundation at a grow support mount on the grow support foundation. Attaching the grow support to the grow support foundation ensures the grow support stays in the proper position as the growing plant pushes against the grow support upwardly during growth, from either inside the grow support or outside the grow support. The grow support can attach to the grow support mount with a pressure fit with the grow support exerting pressure on the grow support mount or the grow support mount clamping on the grow support, however, other attachment methods are contemplated. For example, the grow support can attach to the grow support mount with a quick disconnect release mechanism, a barrel locking mechanism, a sliding locking mechanism, etc.

The grow support foundation can be integrated in the planter being formed from the base of the planter. The grow support foundation being integrated in the base of the planter can permit for easy stacking of the planters as the grow support foundations would fit into the grow support foundations of subsequent planters in the stack. The grow support foundation can be conical in shape, being broader at the base of the planter and narrower at the end with the grow support mount; however, other shapes are contemplated as well. For example, the grow support foundation can be cylindrical, square, pyramidal, hexagonal, rectangular, parallelogram, etc.

The grow support foundation can be removable from the planter. The grow support foundation being removable permits easy stacking and storage of the planters. The removable grow support foundation can include individual risers that mount to the base of the planter; however, other removable grow support foundations are contemplated as well. For example, the removable grow support foundation can include a single structure with multiple risers that attaches to the base of the planter, a single structure with multiple risers that sits in the base of the planter being held in position with the soil in the planter, a single structure that attaches to the sidewall of the planter leaving more space in the planter for soil and the plant, etc. The removable grow support foundation can attach to the planter by threading into a removable grow support foundation mount; however, other attachment methods are contemplated. For example, the removable grow support foundation can attach with a pressure fit with the removable grow support foundation exerting pressure on the removable grow support foundation mount or the removable grow support foundation mount clamping onto the removable grow support foundation, the removable grow support foundation can attach to the removable grow support foundation mount with a quick disconnect release mechanism, a tab and slot mechanism, a barrel locking mechanism, a sliding locking mechanism, etc.

The grow support foundation being integrated in the base of the planter can permit for easy stacking of the planters as the grow support foundations would fit into the grow support foundations of subsequent planters in the stack. This ease in stacking supports more efficient storage and smaller shipping packages of the planters with grow support foundations.

The planters in accordance with the present invention may be fabricated by molding processes using plastics; however, other materials are contemplated as well. For example, the planters may include metal construction, concrete, wood, etc. In one embodiment, the planters are a monolithic construction (e.g., one piece).

It is to be understood that the present invention will be described in terms of a given illustrative architectures; however, other architectures, structures, materials and process features and steps may be varied within the scope of the present invention.

It will also be understood that when an element such as a layer, region or substrate is referred to as being “on” or “over” another element, it can be directly on the other element or intervening elements may also be present. In contrast, when an element is referred to as being “directly on” or “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including”, when used herein, specify the presence of stated features, integers, steps, operations, elements and/or components, but do not preclude the presence or addition of one or more other features, integers, steps, operations, elements, components and/or groups thereof.

Spatially relative s such as “beneath,” “below,” “lower,” “above,” “upper,” the like, may be used herein for ease of description to describe one element's or feature's relationship to another element(s) or feature(s) as illustrated in the FIGS. It will be understood that the spatially relative terms are intended to encompass different orientations of the device in use or operation in addition to the orientation depicted in the FIGS. For example, if the device in the FIGS. is turned over elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein may be interpreted accordingly. In addition, it will also be understood that when a layer is referred to as being “between” two layers, it can be the only layer between the two layers, or one or more intervening layers may also be present.

It will be understood that, although the terms first, second, etc. may be used herein to describe various elements, these elements should not be limited by these terms. These terms are only used to distinguish one element from another element. Thus, a first element discussed below could be termed a second element without departing from the scope of the present concept.

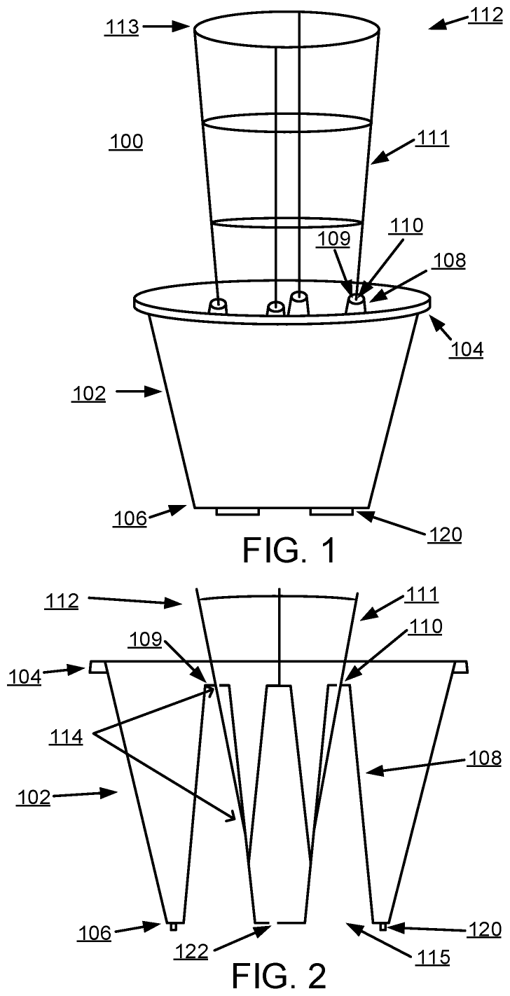

Referring now to the drawings in which like numerals represent the same or similar elements and initially to FIG. 1, a side view of a planter 100 with a grow support 112 is shown in accordance with the present principles.

According to aspects of the present embodiment, the planter 100 may have a base 106 with a grow support foundation 108 and a sidewall 102 upwardly extending therefrom. The base 106 may be, e.g., circular, but may also be square, rectangular, elliptical or any other suitable shape. The base 106 can include feet 120 that lift the base 106 off the surface below for easier drainage. The sidewall 102 may contact edges of the base 106, preferably all around the perimeter of the base 106. In this way, the sidewall 102 may provide a sealed connection to the base 106 such that water and soil may be retained therein.

The sidewall 102 may take any suitable shape for retaining a plant and soil. According to the present embodiments, the sidewall 102 may take a shape that facilitates stacking of multiple planters 100. For example, the sidewall 102 may be circular in cross section and extending vertically from the base 106 to a top circular rim 104, with the radius of the circular cross section increasing in size towards the top circular rim 104. Alternatively, the sidewall 102 may be vertical with a circular cross-section, thus forming a cylinder extending upwards from a circular base 106, or it may include multiple flat sidewalls, thus forming a box shape, or the shape of the cross section may change with height. Other base 106 and sidewall 102 configurations are contemplated.

The grow support foundation 108 can be fixed to the base 106. In one embodiment, the grow support foundation 108 can be integrally formed with the base 106. In other embodiments, the grow support foundation 108 can be formed separately from the base 106 and affixed to the base 106 with epoxy, or other suitable affixing means, for example, e.g., plastic welding, glue, soldering, mechanical fitting, threaded onto a stud on the base, stud threaded into the base, etc. The planter 100 can include a varying number of the grow support foundations 108. In one useful embodiment, the planter 100 can include four grow support foundations 108; however, other numbers of grow support foundations 108 are contemplated. For example, one embodiment of the planter 100 can include three grow support foundations 108, another embodiment of the planter 100 can include five grow support foundations 108, while other embodiments of the planter 100 can include a number of grow support foundations 108 needed to securely hold the grow support 112, depending on the size of the grow support 112 as a larger grow support 112 can use more grow support foundations 108 because of size and weight. The grow support foundation 108 can be formed on the base 106 and have sidewalls that extend substantially vertically upwards (e.g., between 60 and 90 degrees with respect to a horizontal plane). In one embodiment, the grow support foundation 108 can be a mesa. The mesa has sidewalls that extend substantially vertically upwards (e.g., between 60 and 90 degrees with respect to a horizontal plane being broader the base 106 and narrower at the end with a top surface 109. The top surface 109 of the mesa being flat with a grow support mount 110. In another embodiment, the grow support foundation 108 can be conical in shape, being broader at the base 106 and narrower at the end with the top surface 109 and a grow support mount 110. In other embodiments, the grow support foundation 108 can be other shapes, e.g., cylindrical, c, pyramidal, etc. The grow support foundation 108 can extend to varying heights. In one embodiment, the grow support foundation 108 can extend from the base 106 to a height below the top circular rim 104. In other embodiments, the grow support foundation 108 can extend to a height above the top circular rim 104 or the grow support foundations 108 can be of varying heights in the planter 100.

In one embodiment, the top surface 109 of the grow support foundation 108 can be flat with the grow support mount 110 affixed to the top surface 109. In another embodiment, the top surface 109 can taper directly to the grow support mount 110. In other embodiments, the top surface 109 can include a curve portion, a pointed portion, an indented portion, etc. The top surface 109 can include a circular shape; however, other shapes are contemplated as well. For example, the top surface 109 can include square, hexagonal, triangular, rhomboid, parallelogram, etc. shapes. In one embodiment, the grow support mount 110 can attach to the grow support 112 with a pressure fit with the grow support 112 exerting lateral pressure on the grow support mount 110 or the grow support mount 110 can clamp on to the grow support 112. The grow support mount 110 can clamp on to the grow support 112 with for example, e.g., a spring clip, a set screw, a ratcheting jaw, a thread lock, etc. In another embodiment, other attachment mechanisms are contemplated, for example, e.g., the grow support 112 can attach to the grow support mount 110 with a quick disconnect release mechanism, a barrel locking mechanism, a sliding locking mechanism, etc. The grow support 112 can attach to the grow support mount 110 by sliding into the grow support mount 110.

The grow support 112 can include legs 11 or rings 113 and the legs 111. The legs 111 of the grow support 112 attach to the grow support mounts 110 of the planter 100. The legs 111 include a length. The length of the legs 111 can vary depending on the plant being grown in the planter 100, as some plants grow taller and would utilize the grow support 112 with longer legs 111. In one embodiment, the legs 111 can be from about 4 inches to about 72 inches. In another embodiment, the legs can be from about 30 inches to about 48 inches. The legs 111 can include a portion of the attachment mechanism that the grow support mount 110 utilizes to attach to the grow support 112. In one embodiment, the legs are straight. In other embodiments, the legs 111 can include waves, curves, bends, cork screws, zig zags, etc. The rings 113 can attach to the legs 111 to form the grow support 112. In one embodiment, the rings 113 can be a circular shape; however, other shapes are contemplated as well. For example, the rings 113 can be shaped like a square, a triangle, a hexagon, or other appropriate shape depending on the number on the legs 111. The rings 113 can include varying circumferences. In one embodiment, the rings 113 can include circumferences from about 2 inches to about 150 inches. In another embodiment, the rings can include circumferences from about 4 inches to about 72 inches. The grow support 112 can include a uniform width forming a cylinder or form a cone shape. The rings 113 of the grow support 112 that has a uniform width include all the same circumference. The rings 113 of the grow support 112 shaped like a cone will vary in circumference increasing in size along the grow support 112 with the smallest circumference at the end of the grow support 112 that attaches to the grow support foundations 108. The grow support 112 can have varying number of the rings 113. The number of the rings 113 can depend on the length of the legs 111, with more of the rings 113 utilized with longer legs 111. The rings 113 can attach to the legs 111 in intervals of about 6 inches to about 24 inches. In one embodiment, the number of the rings 113 includes enough rings 113 to attach to the legs 111 about every twelve inches. The rings 113 can be solid or jointed. In one embodiment, the rings 113 are solid and fixed. In another embodiment, the rings 113 can be jointed and only partially fixed to the legs 111, giving the ability to open portions of the grow support 112 and alter the grow support 112 structure to accommodate the needs of the plant growing in the planter.

Referring now to FIG. 2, illustratively depicts a cross-sectional view of the planter 100 of FIG. 1 showing the planter 100 with grow support foundations 108 therein in accordance with one embodiment of present invention.

The cross-sectional view of the planter 100 shows the top circular rim 104, the sidewall 102, the base 106, and the feet 120 as described in FIG. 1. The base 106 can include drainage holes 122 to permit excess water to drain from the planter 100. The planter 100 can include a plurality of the grow support foundations 108. The grow support foundations 108 can be mesas. The top surface 109 of the grow support foundation 108 can include the grow support mount 110. In one embodiment, the grow support mount 110 can be a hole that the legs 111 of the grow support 112 passes through, with the legs 111 of the grow support 112 exerting lateral pressure 114 at the support mount 110 and the sidewall of the grow support foundation 108 to attach the grow support 112 to the grow support foundation 108.

The base 106 can include openings 115 at the bottom of the grow support foundations 108. These opening 115 can permit the easy stacking of the planters 100, as the grow support foundations 108 can fit into the openings 115 of the subsequent planter 100 in a stack, thus taking up less space for storage and shipping as a smaller package. In one embodiment, the planter 100 can include a monolithic design with the base 106, the grow support foundations 108, the sidewall 102, and the top circular rim 104 all manufactured from a single piece of material. This could be manufactured with an injection molded system, a vacuum molded system, or other suitable manufacturing process. In other embodiments, the planter 100 can be manufactured as separate parts and then combined to form the planter 100. The base 106, the grow support foundations 108, the sidewall 102, and the top circular rim 104 can be manufactured separately and then combined to form the planter 100. The components can be plastic welded together to form the planter 100; however, other securing methods are contemplated as well. For example, the components can be glued, soldered, welded, epoxied, mechanically attached, etc. Mechanical attachment can include threading together, pressure fitting, or other mechanical mechanisms. It is further contemplated that the components can be combined with different securing methods for example, e.g., the top circular rim 104 can be glued to the sidewall 102, the sidewall 102 can be plastic welded to the base 106, and the grow support foundations 108 can be mechanically attached to the base 106.

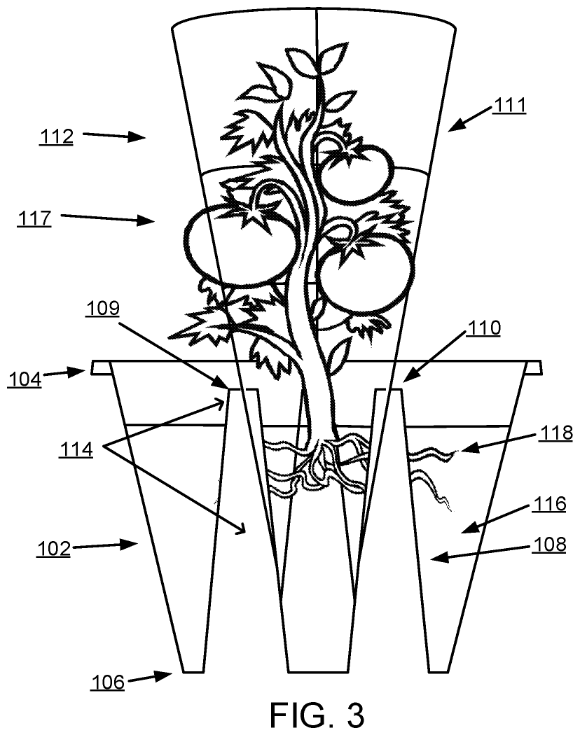

Referring now to FIG. 3, illustratively depicts a cross-sectional view of the planter 100 of FIG. 1 showing the planter 100 with grow support foundations 108 and a plant 117 therein in accordance with one embodiment of present invention.

The cross-sectional view of the planter 100 shows the top circular rim 104, the sidewall 102, and the base 106 as described in FIG. 1. The planter 100 can include a plurality of the grow support foundations 108. The grow support foundations 108 can be mesas. The top surface 109 of the grow support foundation 108 can include the grow support mount 110. In one embodiment, the grow support mount 110 can be a hole that the legs 111 of the grow support 112 passes through, with the legs 111 of the grow support 112 exerting lateral pressure 114 at the support mount 110 and the sidewall of the grow support foundation 108 to attach the grow support 112 to the grow support foundation 108.

The grow support 112 can support the plant 117 as it grows in the planter 100. The cage shape of the grow support 112 permits the plant 117 to grow up away from the planter 100 while being supported. The openings in the grow support 112 permits the plant 117 to also grow out of the grow support 112 as it grows and produces fruit. The plant 117 has a root system 118 that grows into the planter 100. The root system 118 grows in soil 116 located in the planter 100. The soil 116 can fill the planter 110 to different levels. In one embodiment, the soil 116 can come to a level below the top surface 109 of the grow support foundation 108 so that the top surface 109 of the grow support foundation 108 is exposed above the soil 116. In other embodiments, the soil 116 can come to a level that covers the top surface 109 of the grow support foundation 108 or the soil can come to a level equal to the top surface 109 of the grow support foundation 108.

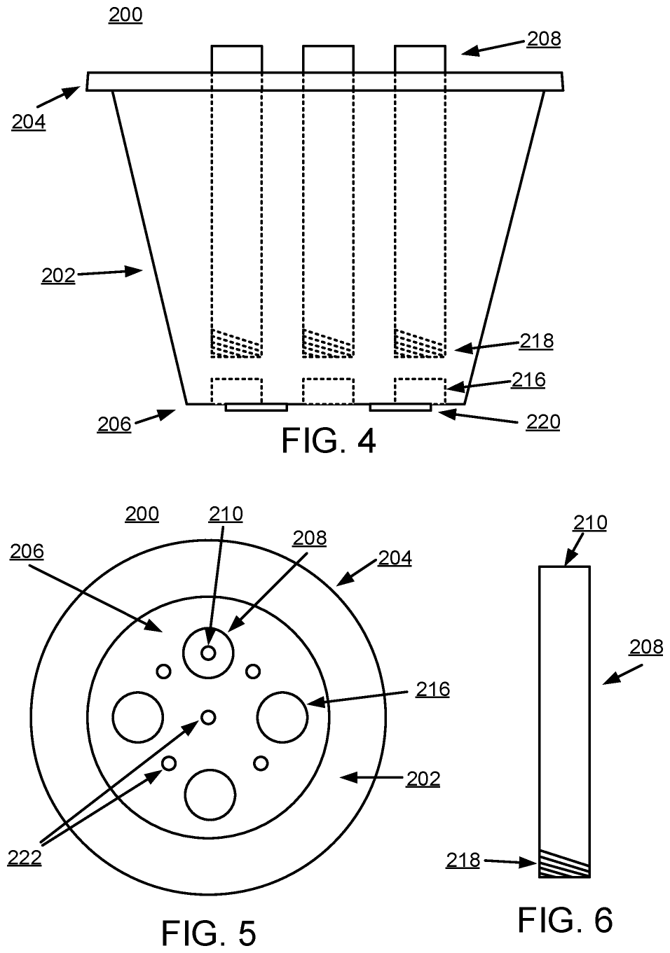

Referring now to FIG. 4, illustratively depicts a side view of a planter 200 with removable grow support foundations 208 therein in accordance with another embodiment of present invention.

According to aspects of the present embodiment, planter 200 may have the base 206 with the sidewall 202 upwardly extending therefrom. The base 206 may be, e.g., circular, but may also be square, rectangular, elliptical or any other suitable shape. The base 206 can include feet 220 that lift the base 206 off the surface below for easier drainage. The sidewall 202 may contact edges of the base 206, preferably all around the perimeter of the base 206. In this way, the sidewall 202 may provide a sealed connection to the base 206 such that water and soil may be retained therein.

The sidewall 202 may take any suitable shape for retaining a plant and soil. According to the present embodiments, the sidewall 202 may take a shape that facilitates stacking of multiple planters 200. For example, the sidewall 202 may be circular in cross section and extending vertically from the base 206 to a top circular rim 204, with the radius of the circular cross section increasing in size towards the circular rim 204. Alternatively, the sidewall 202 may be vertical with a circular cross-section, thus forming a cylinder extending upwards from a circular base 206, or it may include multiple flat sidewalls, thus forming a box shape, or the shape of the cross section may change with height. Other base 206 and sidewall 202 configurations are contemplated

The base 206 can include support foundation mounts 216. The support foundation mounts 216 attach the removable grow support foundations 208 to the planter 200. In one embodiment, the support foundation mount 216 are attached to the base 206 and accept the removable grow support foundation 208. In another embodiment, the support foundation mount 216 is integrated into the base 206. The support foundation mount 216 can include threading that mates with threading 218 on the removable grow support foundation 208 for example, e.g., the removable grow support foundation 208 threads into the support foundation mount 216, the removable grow support foundation 208 threads onto the support foundation mount 216, the removable grow support foundation 208 can include a threaded stud that screws into the support foundation mount 216, the support foundation mount 216 includes a threaded stud that the removable grow support foundation 208 screws onto, etc. In other embodiments, the support foundation mount 216 can include a quick discount mounting system, a sliding barrel mounting system, a spring lock mounting system, a pressure fit system, etc. In one embodiment, the removable grow support foundation 208 can be cylindrical in shape; however, other shapes are contemplated as well. For example, the removable grow support foundation 208 can be conical, square, pyramidal, etc.

Referring now to FIG. 5, illustratively depicts a top view of a planter 200 with the removable grow support foundation 208 and the support foundation mounts 216 therein in accordance with another embodiment of present invention.

The top view of the planter 200 shows the top circular rim 204, the sidewall 202, and the base 206 as described in FIG. 4. The base 20 can include drainage holes 222 to permit excess water to drain from the planter 200. The planter 200 can include a plurality of the support foundation mount 216. The support foundation mount 216 can be circular in shape; however, other shapes are contemplated as well. For example, the grow support foundation mount 216 can be hexagonal, square, pyramidal, etc. The removable grow support foundation 208 can lock into the support foundation mount 216. In one embodiment, the support foundation mounts 216 can be evenly spaced around the perimeter of the base 206, however, other spacing in contemplated. For example, the support foundation mounts 216 can be clustered in groups on the base 206, located in a zig zag pattern on the base 206, positioned equally along a circle halfway between the center of the base 206 and the sidewall 202, positioned equally along a circle three-quarters distance between the center of the base 206 and the sidewall 202, positioned at the center of the base 206, etc.

The removable grow support foundation 208 can include a grow support mount 210. In one embodiment, the grow support mount 210 include a hole that the grow support 112 can lock into. In another embodiment, the grow support mount 210 can attach to the grow support 112 with a pressure fit with the grow support 112 exerting lateral pressure on the grow support mount 210 or the grow support mount 210 can clamp on to the grow support 112. The grow support mount 210 can clamp on to the grow support 112 with for example, e.g., a spring clip, a set screw, a ratcheting jaw, a thread lock, etc. In another embodiment, other attachment means are contemplated, for example, e.g., the grow support 112 can attach to the grow support mount 210 with a quick disconnect release mechanism, a barrel locking mechanism, a sliding locking mechanism, etc.

Referring now to FIG. 6, illustratively depicts the removable grow support foundation 208 in accordance with another embodiment of present invention.

The removable grow support foundation 208 can be cylindrical in shape; however, other shapes are contemplated as well. For example, the removable grow support foundation 208 can be conical, square, pyramidal, etc. The removable grow support foundation 208 can include the grow support mount 210 on one end of the removable grow support foundation 208. The grow support mount 210 can be integrated into or attached to the removable grow support foundation 208. The removable grow support foundation 208 can include an attachment system to mount the removable grow support foundation 208 to the support foundation mount 216 in the planter 200. The attachment system can include threads 218, where the removable grow support foundation 208 threads into the support foundation mount 216 or the removable grow support foundation 208 threads onto the support foundation mount 216; however, other attachment systems are contemplated as well. For example, the removable grow support foundation 208 can attach by a pressure fit with the removable grow support foundation 208 exerting pressure on the support foundation mount 216 or the support foundation mount 216 clamping on the removable grow support foundation 208, the removable grow support foundation 208 can attach to the support foundation mount 216 with a quick disconnect release mechanism, a barrel locking mechanism, a sliding locking mechanism, etc.

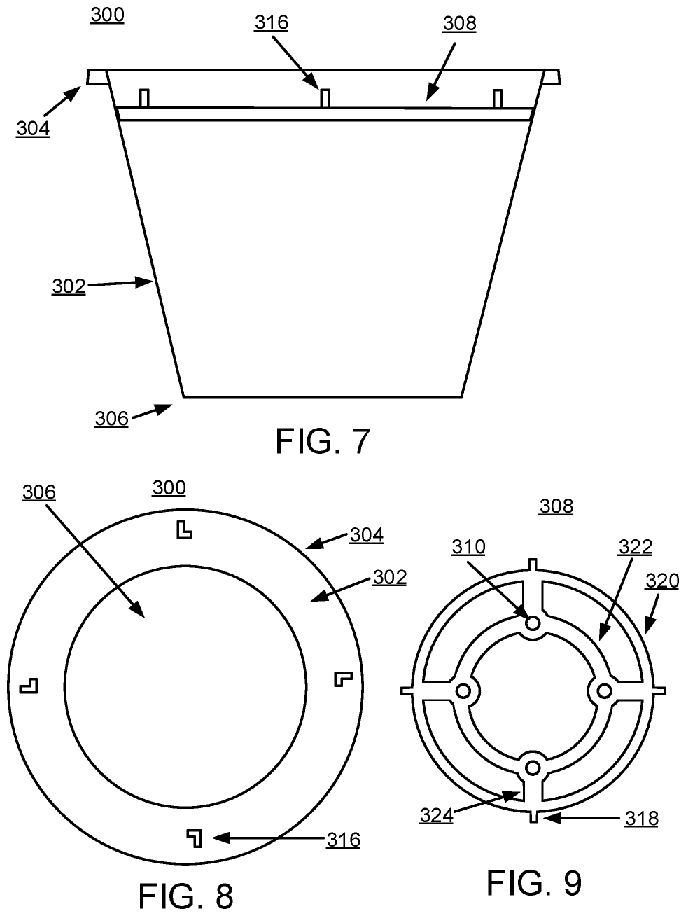

Referring now to FIG. 7, illustratively depicts a cross-sectional view of a planter 300 with a removable grow support foundation 308 therein in accordance with another embodiment of present invention.

According to aspects of the present embodiment, planter 300 may have the base 306 with the sidewall 302 upwardly extending therefrom. The base 306 may be, e.g., circular, but may also be square, rectangular, elliptical or any other suitable shape. The sidewall 302 may contact edges of the base 306, preferably all around the perimeter of the base 306. In this way, the sidewall 302 may provide a sealed connection to the base 306 such that water and soil may be retained therein.

The sidewall 302 may take any suitable shape for retaining a plant and soil. According to the present embodiments, the sidewall 302 may take a shape that facilitates stacking of multiple planters 300. For example, the sidewall 302 may be circular in cross section and extending vertically from the base 306 to a top circular rim 304, with the radius of the circular cross section increasing in size towards the top circular rim 304. Alternatively, the sidewall 302 may be vertical with a circular cross-section, thus forming a cylinder extending upwards from a circular base 306, or it may include multiple flat sidewalls, thus forming a box shape, or the shape of the cross section may change with height. Other base 306 and sidewall 302 configurations are contemplated

The base 306 can include support foundation mounts 316. The support foundation mounts 316 attach the removable grow support foundation 308 to the planter 300. In one embodiment, the support foundation mounts 316 can be cut into the sidewall 302 and accept the removable grow support foundation 308. In another embodiment, the support foundation mounts 316 are attached to the sidewall 302. In other embodiments, the support foundation mounts 316 can include a quick discount mounting system, a sliding barrel mounting system, a spring lock mounting system, a pressure fit system, etc. In one embodiment, the removable grow support foundation 308 can be circular in shape; however, other shapes are contemplated as well. For example, the removable grow support foundation 308 can be hexagonal, square, pyramidal, etc.

Referring now to FIG. 8, illustratively depicts a top view of a planter 300 with the support foundation mounts 316 therein in accordance with another embodiment of present invention.

The top view of the planter 300 shows the top circular rim 304, the sidewall 302, and the base 306 as described in FIG. 7. The planter 300 can include a plurality of the support foundation mounts 316. The support foundation mounts 316 can be cut into the sidewall 302; however, other mounts are contemplated as well. For example, the grow support foundation mounts 316 can be attached to the sidewall 302, can be formed from the sidewall 302 as protrusions, etc. The removable grow support foundation 308 can lock into or onto the support foundation mounts 316.

Referring now to FIG. 9, the removable support foundation 308 in accordance with another embodiment of present invention is illustratively depicted.

The removable grow support foundation 308 can be circular in shape; however, other shapes are contemplated as well. For example, the removable grow support foundation 308 can be hexagonal, square, triangular, etc. The removable grow support foundation 308 can include an outer ring 320 and a grow ring 322. The outer ring 320 can center the removable grow support foundation 308 in the planter 300 for easy placement. The outer ring 320 can include an attachment system to attach the removable grow support foundation 308 to the planter 300. The attachment system can include attachment tabs 318 that fit into the support foundation mounts 316 in the sidewall 302 of the planter 300; however, other attachment systems are contemplated as well. For example, the support foundation mounts 316 can clamp on to removable grow support foundation 308 with for example, e.g., a spring clip, a set screw, a ratcheting jaw, a thread lock, etc. In another embodiment, other attachment means are contemplated, for example, e.g., removable grow support foundation 308 can attach to the support foundation mounts 316 with a quick disconnect release mechanism, a barrel locking mechanism, a sliding locking mechanism, etc.

The grow ring 322 is separated from and connected to the outer ring 320 by ring supports 324. The grow ring 322 can include a grow support mount 310. In one embodiment, the grow support mount 310 include a hole that the grow support 112 can lock into. In another embodiment, the grow support mount 310 can attach to the grow support 112 with a pressure fit with the grow support 112 exerting lateral pressure on the grow support mount 310 or the grow support mount 310 can clamp on to the grow support 112. The grow support mount 310 can clamp on to the grow support 112 with for example, e.g., a spring clip, a set screw, a ratcheting jaw, a thread lock, etc. In another embodiment, other attachment means are contemplated, for example, e.g., the grow support 112 can attach to the grow support mount 310 with a quick disconnect release mechanism, a barrel locking mechanism, a sliding locking mechanism, etc.

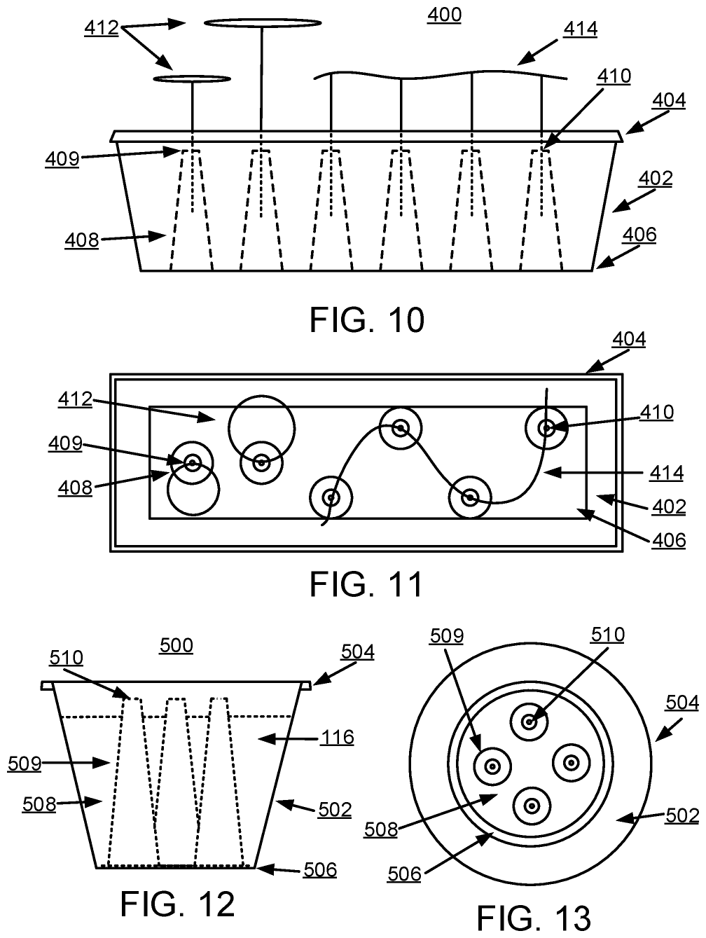

Referring now to FIG. 10, illustratively depicts a cross-sectional view of a planter 400 with grow support foundations 408 and the grow supports 112 therein in accordance with another embodiment of present invention.

According to aspects of the present embodiment, planter 400 may have the base 406 with the sidewall 402 upwardly extending therefrom. The base 406 may be, e.g., rectangular, but may also be square, circular, elliptical or any other suitable shape. The sidewall 402 may contact edges of the base 406, preferably all around the perimeter of the base 406. In this way, the sidewall 402 may provide a sealed connection to the base 406 such that water and soil may be retained therein.

The sidewall 402 may take any suitable shape for retaining a plant and soil. According to the present embodiments, the sidewall 402 may take a shape that facilitates stacking of multiple planters 400. For example, the sidewall 402 may be rectangular in cross section and extending vertically from the base 406 to a top rim 404, with the circumference of the rectangular cross section increasing in size towards the top rim 404. Alternatively, the sidewall 402 may be vertical with a circular cross-section, thus forming a cylinder extending upwards from a circular base 406, or it may include multiple flat sidewalls, thus forming a box shape, or the shape of the cross section may change with height. Other base 406 and sidewall 402 configurations are contemplated

The base 406 can include openings at the bottom of the grow support foundations 408. These opening can permit the easy stacking of the planters 400, as the grow support foundations 408 can fit into the openings 415 of the subsequent planter 400 in a stack, thus taking up less space for storage and shipping as a smaller package. In one embodiment, the planter 400 can include a monolithic design with the base 406, the grow support foundations 408, the sidewall 402, and the top rim 404 all manufactured from a single piece of material. This could be manufactured with an injection molded system, a vacuum molded system, or other suitable manufacturing process. In other embodiments, the planter 400 can be manufactured as separate parts and then combined to form the planter 400. The base 406, the grow support foundations 408, the sidewall 402, and the top rim 404 can be manufactured separately and then combined to form the planter 400. The components can be plastic welded together to form the planter 400; however, other securing methods are contemplated as well. For example, the components can be glued, soldered, welded, epoxied, mechanically attached, etc. Mechanical attachment can include threading together, pressure fitting, or other mechanical mechanisms. It is further contemplated that the components can be combined with different securing methods for example, e.g., the top circular rim 404 can be glued to the sidewall 402, the sidewall 402 can be plastic welded to the base 406, and the grow support foundations 408 can be mechanically attached to the base 406.

The grow support foundation 408 can be fixed to the base 406. In one embodiment, the grow support foundation 408 can be integrally formed with the base 406. In other embodiments, the grow support foundation 408 can be formed separately from the base 406 and affixed to the base 406 with epoxy, or other suitable affixing means, for example, e.g., plastic welding, glue, soldering, mechanical fitting, threaded onto a stud on the base, stud threaded into the base, etc. The planter 400 can include a varying number of the grow support foundations 408. In one useful embodiment, the planter 400 can include six grow support foundations 408; however, other numbers of grow support foundations 408 are contemplated. For example, one embodiment of the planter 400 can include three grow support foundations 408, another embodiment of the planter 400 can include five grow support foundations 408, while other embodiments of the planter 400 can include a number of grow support foundations 408 needed to securely hold the grow support 412, depending on the size of the grow support 412 as a larger grow support 412 can use more grow support foundations 408 because of size and weight. The grow support foundation 408 can be formed on the base 406 and have sidewalls that extend substantially vertically upwards (e.g., between 60 and 90 degrees with respect to a horizontal plane). In one embodiment, the grow support foundation 408 can be a mesa. The mesa has sidewalls that extend substantially vertically upwards (e.g., between 60 and 90 degrees with respect to a horizontal plane being broader the base 406 and narrower at the end with a top surface 409. The top surface 409 of the mesa being flat with a grow support mount 410. In another embodiment, the grow support foundation 408 can be conical in shape, being broader at the base 406 and narrower at the end with the top surface 409 and a grow support mount 410. In other embodiments, the grow support foundation 408 can be other shapes, e.g., cylindrical, c, pyramidal, etc. The grow support foundation 408 can extend to varying heights. In one embodiment, the grow support foundation 408 can extend from the base 406 to a height below the top circular rim 404. In other embodiments, the grow support foundation 408 can extend to a height above the top circular rim 404 or the grow support foundations 408 can be of varying heights in the planter 400.

In one embodiment, the top surface 409 of the grow support foundation 408 can be flat with the grow support mount 410 affixed to the top surface 409. In another embodiment, the top surface 409 can taper directly to the grow support mount 410. In other embodiments, the top surface 409 can include a curve portion, a pointed portion, an indented portion, etc. The top surface 409 can include a circular shape; however, other shapes are contemplated as well. For example, the top surface 409 can include square, hexagonal, triangular, rhomboid, parallelogram, etc. shapes. In one embodiment, the grow support mount 410 can attach to the grow support 412 with a pressure fit with the grow support 412 exerting lateral pressure on the grow support mount 410 or the grow support mount 410 can clamp on to the grow support 412. The grow support mount 410 can clamp on to the grow support 412 with for example, e.g., a spring clip, a set screw, a ratcheting jaw, a thread lock, etc. In another embodiment, other attachment mechanisms are contemplated, for example, e.g., the grow support 412 can attach to the grow support mount 410 with a quick disconnect release mechanism, a barrel locking mechanism, a sliding locking mechanism, etc. The grow support 412 can attach to the grow support mount 410 by sliding into the grow support mount 410.

The planter 400 can utilize a single grow support 112 or a plurality of the grow supports 112. In one embodiment, the grow support 112 can include a single ring grow support 412. The single ring grow support 412 can be utilized in several of the grow support foundations 408. In another embodiment, the grow support can include a multi-leg curved grow support 414. The multi-leg curved grow support 414 can be utilized across several of the grow support foundations 408.

Referring now to FIG. 11, illustratively depicts a top view of a planter 400 with the grow support foundations 408 and the grow supports 112 therein in accordance with another embodiment of present invention.

The top view of the planter 400 shows the top rim 404, the sidewall 402, and the base 406 as described in FIG. 10. The planter 400 can include a plurality of the grow support foundations 408. The grow support foundations 408 can include the top surface 409 and the grow support mount 410. Several of the grow support foundations 408 can attached to the single ring grow support 412. Several other of the grow support foundations 408 can attached to the multi-leg curved grow support 414.

The grow support foundations 408 can be located variably on the base 406. In one embodiment, the grow support foundations 408 can be equally spaced along a long axis of the base 406. The long axis if the base can be in the center of the base or any other axis along the base 406. In other embodiments, the grow support foundations 408 can be located in a zig zag pattern along a long axis on the base 406. The zip zag pattern can space the grow support foundations 408 to be substantially on the long axis to the edge of the base 406 where the base 406 meets the sidewall 402, however other locations are contemplated. For example, the grow support foundations 408 can be randomly spaced along the base 406, clustered in groups at the ends of base 406, spaced along a Fibonacci spiral on the base 406, etc.

Referring now to FIG. 12, illustratively depicts a side view of a planter 500 with a removable grow support foundation 508 therein in accordance with another embodiment of present invention.

According to aspects of the present embodiment, planter 500 may have the base 506 with the sidewall 502 upwardly extending therefrom. The base 506 may be, e.g., circular, but may also be square, rectangular, elliptical or any other suitable shape. The sidewall 502 may contact edges of the base 506, preferably all around the perimeter of the base 506. In this way, the sidewall 502 may provide a sealed connection to the base 506 such that water and soil may be retained therein.

The sidewall 502 may take any suitable shape for retaining a plant and soil 116. According to the present embodiments, the sidewall 502 may take a shape that facilitates stacking of multiple planters 500. For example, the sidewall 502 may be circular in cross section and extending vertically from the base 506 to a top circular rim 504, with the radius of the circular cross section increasing in size towards the circular rim 504. Alternatively, the sidewall 502 may be vertical with a circular cross-section, thus forming a cylinder extending upwards from a circular base 506, or it may include multiple flat sidewalls, thus forming a box shape, or the shape of the cross section may change with height. Other base 506 and sidewall 502 configurations are contemplated

The removable grow support foundation 508 can include a plurality of support pilons 509. The removable grow support foundation 508 can be a single monolithic piece or a combination of several other pieces combined to form the removable grow support foundation 508. Each support pilon 509 can include a grow support mount 510. In one embodiment, the support pilons 509 include mesas. In other embodiments, the support pilon 509 can include cylinders, pyramids, rectangular blocks, etc. The removable grow support foundation 508 can be held in place in the planter 500 with the soil 116. In other embodiments, the removable grow support foundation 508 can be attached the base 506. For example, the removable grow support foundation 508 can thread into the base 506, however other attachment methods are contemplated. For example, the removable grow support foundation 508 can include a threaded stud that screws into the base 506, the base 506 includes a threaded stud that the removable grow support foundation 508 screws onto, etc. In other embodiments, the support foundation mount 216 can include a quick discount mounting system, a sliding barrel mounting system, a spring lock mounting system, a pressure fit system, etc. In one embodiment, the removable grow support foundation 508 can be circular in shape; however, other shapes are contemplated as well. For example, the removable grow support foundation 508 can be rectangular, square, hexagonal, etc.

Referring now to FIG. 13, illustratively depicts a top view of a planter 500 with the removable grow support foundation 508 therein in accordance with another embodiment of present invention.

The top view of the planter 500 shows the top circular rim 504, the sidewall 502, and the base 506 as described in FIG. 12. The planter 500 can includes removable grow support foundation 508. The removable grow support foundation 508 can be circular in shape; however, other shapes are contemplated as well. For example, the removable grow support foundation 508 can be hexagonal, square, rectangular, etc. The removable grow support foundation 508 can lock into the base 506. In one embodiment, the removable grow support foundation 508 is held in position by the soil 116 placed on the removable grow support foundation 508. The removable grow support foundation 508 can include a plurality of support pilons 509. The support pilons 509 can be evenly spaced around the perimeter of the removable grow support foundation 508, however, other spacing in contemplated. For example, the support pilons 509 can be clustered in groups on the removable grow support foundation 508, located in a zig zag pattern on the removable grow support foundation 508, positioned equally along a circle halfway between the center of the removable grow support foundation 508 and an edge of the removable grow support foundation 508, positioned equally along a circle three-quarters distance between the center of the removable grow support foundation 508 and the edge of the removable grow support foundation 508, positioned at the center of the removable grow support foundation 508, etc.

The support pilons 509 can include a grow support mount 510. In one embodiment, the grow support mount 510 include a hole that the grow support 112 can lock into. In another embodiment, the grow support mount 510 can attach to the grow support 112 with a pressure fit with the grow support 112 exerting lateral pressure on the grow support mount 510 or the grow support mount 510 can clamp on to the grow support 112. The grow support mount 510 can clamp on to the grow support 112 with for example, e.g., a spring clip, a set screw, a ratcheting jaw, a thread lock, etc. In another embodiment, other attachment means are contemplated, for example, e.g., the grow support 112 can attach to the grow support mount 510 with a quick disconnect release mechanism, a barrel locking mechanism, a sliding locking mechanism, etc.

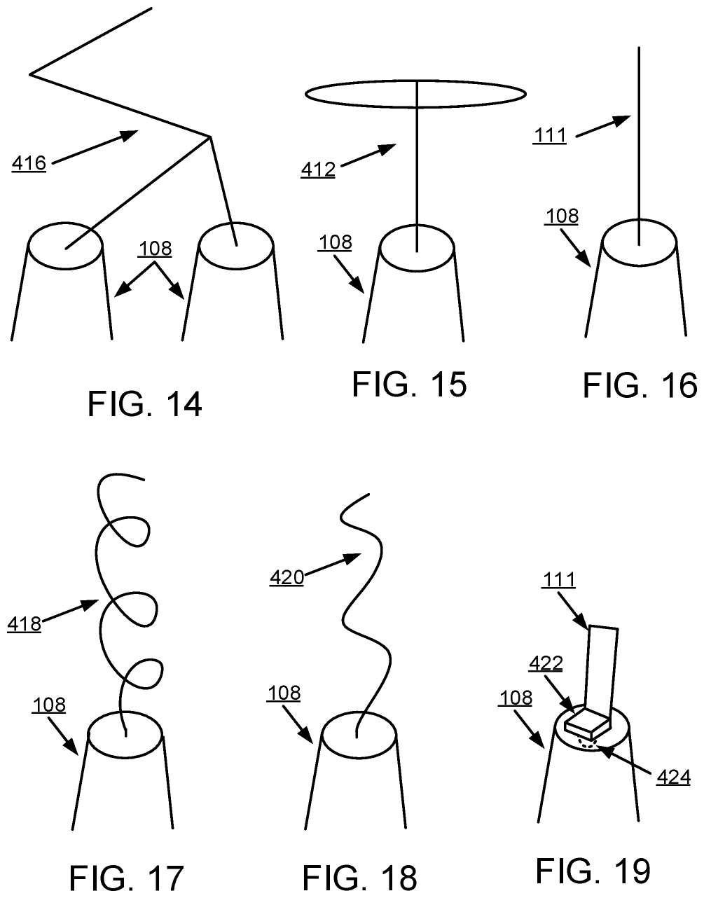

Referring now to FIG. 14, illustratively depicts a view of the grow support foundations 108 with a grow support in accordance with another embodiment of present invention.

The grow support is attached to several of the grow support foundations 108. The grow support is a zig zag grow support 416 that attaches to more than one of the grow support foundations 108. The zig zag grow support 416 can include random bends and angles to support the plant growth. The attachment to more than one of the of the grow support foundations 108 gives the zig zag grow support 416 the needed support to keep the random bends and angles in position above the planter.

Referring now to FIG. 15, illustratively depicts a view of the grow support foundation 108 with a grow support in accordance with another embodiment of present invention.

The grow support is attached to the grow support foundation 108. The grow support is a single ring grow support 416 that can surround an area next to the grow support foundation 108. The single ring grow support 416 permits multiple plants to be planted in the planter and each have an individual grow support.

Referring now to FIG. 16, illustratively depicts a view of the grow support foundation 108 with a grow support in accordance with another embodiment of present invention.

The grow support is attached to the grow support foundation 108. The grow support is a leg 111 stands directly above the grow support foundation 108. The leg 111 permits a plant to be tied to the leg 111 to grow vertically from the planter. The leg 111 permits multiple plants to be planted in the planter and each have an individual grow support.

Referring now to FIG. 17, illustratively depicts a view of the grow support foundation 108 with a grow support in accordance with another embodiment of present invention.

The grow support is attached to the grow support foundation 108. The grow support is a cork screw grow support 418 that tightly supports a plant growing vertically about the grow support foundation 108 without the need to tie the plant to the cork screw grow support 418. The cork screw grow support 418 permits multiple plants to be planted in the planter and each have an individual grow support.

Referring now to FIG. 18, illustratively depicts a view of the grow support foundation 108 with a grow support in accordance with another embodiment of present invention.

The grow support is attached to the grow support foundation 108. The grow support is a wiggle grow support 420 that supports a plant growing vertically about the grow support foundation 108 without the need to tie the plant to the wiggle grow support 420. The wiggle grow support 420 permits multiple plants to be planted in the planter and each have an individual grow support.

Referring now to FIG. 19, illustratively depicts a view of the grow support foundation 108 with a grow support in accordance with another embodiment of present invention.

The grow support is attached to the grow support foundation 108. The grow support is a leg 111. The leg 111 can include a leg base 422 that sits on the grow support foundation 108. The leg base 422 can include a support clip 424 that can be inserted into the grow support foundation 108 to affix the leg 111 to the grow support foundation 108. The support clip 424 can pass through an opening in the grow support foundation 108 and lock the leg 111 in place with friction base on the shape of the support clip 424.

Having described preferred embodiments for planters with grow cage supports (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is desired to be protected by Letters Patent is set forth.

What is claimed is:

1. A planter, comprising:
a base with at least one mesa structure in a central portion of the base;
each mesa structure having a support receiving opening configured to receive a grow support; and
the grow support configured to attach to the planter at the support receiving holes to collectively form a plant support to support a plant growing the in the planter.

2. The planter of claim 1, wherein the support receiving opening is in a top surface the mesa structure that accepts legs of the grow support.

3. The planter of claim 2, wherein the support receiving opening has a securing mechanism for locking the grow support to the planter.

4. The planter of claim 3, wherein the securing mechanism is a set screw.

5. The planter of claim 3, wherein the securing mechanism is a quick discount lock.

6. The planter of claim 2, wherein the support receiving opening applies pressure to the legs of the grow support to secure the grow support to the planter.

7. The planter of claim 1, wherein the mesa structure extends to a height that is below a top rim of a planter sidewall.

8. The planter of claim 1, wherein the mesa structure extends to a height that is above a top rim of a planter sidewall.

9. The planter of claim 1, wherein the planter is of monolithic construction.

10. The planter of claim 1, wherein the mesa structure forms an opening in the base.

11. The planter of claim 1, wherein the planter includes four of the mesa structures.

12. The planter of claim 1, wherein the mesa structure is detachable from the planter.

13. A planter, comprising:
a base including a plurality of openings;
at least one planter sidewall formed with the base;
a grow support foundation formed on the base over each of the plurality of openings and extending substantially vertically upwards from the base; and
a grow support mount on the grow support foundation for attaching a grow support to the planter.

14. The planter of claim 13, wherein the grow support mount is a hole in a top surface of the grow support foundation that accepts a leg of the grow support.

15. The planter of claim 14, wherein the hole applies pressure to the leg of the grow support to secure the grow support to the planter.

16. The planter of claim 15, wherein the grow support foundation extends to a height that is below a top rim of the at least one planter sidewall.

17. The planter of claim 16, wherein the plurality of openings includes four openings.

18. The planter of claim 12, wherein the grow support foundation is detachable from the planter.

19. A planter, comprising:
a base with at least one substantially vertical planter sidewall formed with the base;
a grow support foundation attached to the at least one substantially vertical planter sidewall; and
a plurality of grow support mounts on the grow support foundation for attaching a grow support to the planter.

20. The planter of claim 19, wherein the grow support foundation includes an outer ring for against the at least one substantially vertical planter sidewall connected to a grow ring that supports the plurality of grow support mounts.
